(19) United States
(12) Patent Application Publication
(10) Pub. No.: US 2025/0274793 A1
(43) Pub. Date: Aug. 28, 2025

(54) CHANNEL STATE INFORMATION (CSI) MEASUREMENT AND REPORTING FOR SCALABLE MULTIPLE-INPUT MULTIPLE-OUTPUT (MIMO) COMMUNICATION ON A DOWNLINK

(71) Applicant: Apple Inc., Cupertino, CA (US)

(72) Inventors: Yushu Zhang, Beijing (CN); Sigen Ye, Whitehouse Station, NJ (US); Huaning Niu, San Jose, CA (US); Weidong Yang, San Diego, CA (US); Chunxuan Ye, San Diego, CA (US); Haitong Sun, Cupertino, CA (US); Dawei Zhang, Saratoga, CA (US); Oghenekome Oteri, San Diego, CA (US); Wei Zeng, Saratoga, CA (US)

(21) Appl. No.: 18/857,984

(22) PCT Filed: Apr. 21, 2022
(86) PCT No.: PCT/CN2022/088151

§ 371 Date: Oct. 18, 2024

(51) Int. Cl. H04W 24/10; H04L 5/00

(52) U.S. Cl. CPC H04W 24/10; H04L 5/0053

(57) ABSTRACT

A user equipment (UE) includes a processor configured to receive, from a radio access network (RAN), at least one channel state information (CSI) report configuration. The at least one CSI report configuration identifies two or more (N) codebooks. Each codebook of the N codebooks is based on a respective set of antenna ports of two or more sets of antenna ports. The two or more sets of antenna ports include a first set of antenna ports and one or more additional sets of antenna ports. Each of the one or more additional sets of antenna ports includes a respective set of antenna ports selected from the first set of antenna ports. The processor is further configured to measure CSI based on at least one of the N codebooks, and transmit, to the RAN, at least one CSI report based on the measured CSI.

### TECHNICAL FIELD

This application relates generally to wireless communication systems, including methods and implementations of measuring and reporting channel state information (CSI).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®)

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows a set of antenna ports that may be used to transmit a downlink signal.

FIG. 2 shows an example timeline including a gNB transmission of a PDCCH, a gNB allocation of CMR and IMR resources, and a UE transmission of a CSI report including an optional TA.

FIG. 3 shows an example method 300 of wireless communication by a UE, which method 300 may be used to configure measurement and reporting of CSI for multiple sets of antenna ports.

FIGS. 4A-4C show example sets of antenna ports on which the codebooks identified in one or more CSI report configurations may be based.

FIG. 5A shows application of separate CPU occupancy rules to different codebooks.

FIG. 5B shows application of a common CPU occupancy rule to multiple codebooks.

FIG. 6 shows an example method of wireless communication by a base station, which method may be used to configure measurement and reporting of CSI for multiple sets of antenna ports.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In a scalable multiple-input and multiple-output (MIMO) wireless communication system, a 3GPP network (hereafter referred to as “network”) may transmit different downlink signals, at different times, using different numbers of antenna ports. The number of antenna ports used to transmit a particular downlink signal may be based on factors such as dynamic point(s) selection (e.g., transmission and reception point (TRP) selection), interference management, and network power saving considerations. As an example, a base station (e.g., a gNB) having 32 antenna ports may use 8 antenna ports for transmission of a first downlink signal, and 4 antenna ports for transmission of a second downlink signal (or for transmission of the first downlink signal at a different time).

Since 3GPP Release 15 (Rel-15), a gNB has been able to configure a UE to measure CSI based on a codebook configured in a CSI report configuration (CSI-reportConfig). See, e.g., 3GPP technical specification (TS) 38.331, § 6.3.2. In a codebook configuration (CodebookConfig, or just codebook), a gNB can indicate values of N1 and N2, which values indicate the number of antenna ports to be used, by the gNB, in a downlink transmission. N1 indicates a number of antenna ports spanning a horizontal or first dimension of an antenna panel (or antenna array), and N2 indicates a number of antenna ports spanning a vertical or second dimension of the antenna panel. The gNB may also configure, as part of the codebook, the type of codebook for a CSI report. A UE should measure and report CSI based on the configured codebook. A gNB may also configure, in the CSI report configuration, a list of channel measurement resources (CMRs), a list of non-zero-power (NZP) based interference measurement resources (IMRs) (NZP-IMRs), and a list of CSI interference measurement (CSI-IM) resources.

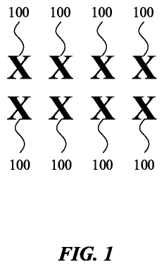

FIG. 1 shows an example set of antenna ports 100 that may be used to transmit a downlink signal (or, equivalently, make a downlink transmission). The set of antenna ports 100 may be associated with a codebook, which codebook may be configured by a gNB in a CSI report configuration. By way of example, the set of antenna ports 100 is shown to include (N1, N2)=(4, 2) antenna ports 100.

For an aperiodic CSI report, 3GPP Rel-15 indicates that gNB scheduling of a CSI report should follow minimum Z and Z′ requirements, defined by minimum Z and Z′ values. The minimum Z value is defined as an offset between a last symbol of a physical downlink control channel (PDCCH) and a first symbol of a CSI report including an optional timing adjustment (TA). The minimum Z′ value is defined as an offset between a last symbol of a channel measurement resource (CMR) or an interference measurement resource (IMR) and the first symbol of the CSI report including the optional TA. A gNB should not schedule a CSI report that violates the minimum Z and Z′ requirements. If a gNB violates the minimum Z and Z′ requirements, the CSI report received by the gNB may be outdated.

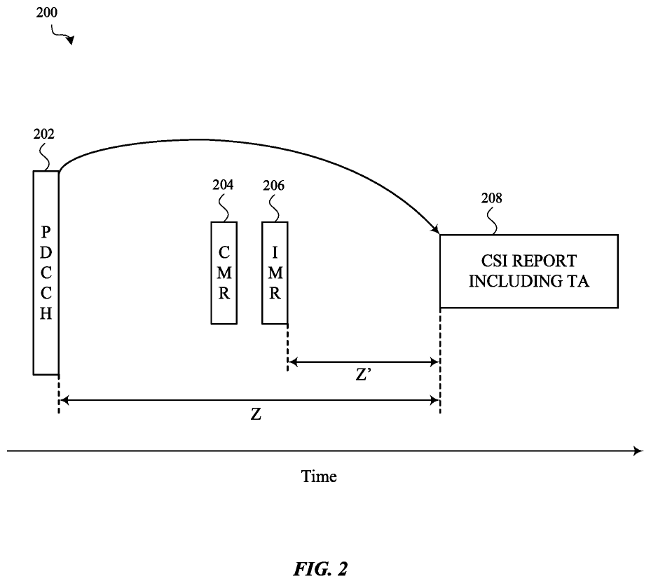

FIG. 2 shows an example timeline 200 including a gNB transmission of a PDCCH 202, a gNB allocation of CMR 204 and IMR 206 resources, and a UE transmission of a CSI report 208 including an optional TA. The PDCCH 202 may include a CSI report configuration. The CSI report configuration may indicate the minimum Z and Z′ requirements for transmission of the CSI report 208.

3GPP Rel-15 and 3GPP Rel-16 define a CSI processing unit (CPU). See, e.g., 3GPP TS 38.214, § 5.2.1.6. In some cases, a UE may process a single CSI measurement and CSI report. In some cases, a UE may process more than one CSI measurement and/or CSI report. The number of CSI measurements and reports that a UE can process within a given time may be based on the number of CPUs that the UE can support. For example, a UE having multiple CPUs may be able to perform multiple measurements in parallel, while a UE that has only one CPU may have to perform multiple measurements sequentially. A UE may report its maximum number of CPUs to a gNB in UE capability information.

3GPP Rel-15/Rel-16 defines a CPU occupancy rule as follows (for a CSI report with reportQuantity not set to ‘none’). A periodic or semi-persistent CSI report (excluding an initial semi-persistent CSI report on a physical uplink shared channel (PUSCH) after the PDCCH triggering the report) occupies CPU(s) from the first symbol of the earliest one of each CSI reference signal (CSI-RS)/CSI-IM/synchronization signal block (SSB) resource for channel or interference measurement, respective latest CSI-RS/CSI-IM/SSB occasion no later than the corresponding CSI reference resource, until the last symbol of the configured PUSCH/physical uplink control channel (PUCCH) carrying the report. An aperiodic CSI report occupies CPU(s) from the first symbol after the PDCCH triggering the CSI report until the last symbol of the scheduled PUSCH carrying the report. An initial semi-persistent CSI report on PUSCH after the PDCCH trigger occupies CPU(s) from the first symbol after the PDCCH until the last symbol of the scheduled PUSCH carrying the report.

Currently, the framework provided by 3GPP for measuring and reporting CSI only supports a single CSI measurement and reporting configuration, for one set of antenna ports. Configuration of CSI measurement and reporting for multiple sets of antenna ports (i.e., two or more sets of antenna ports) may be useful in a scalable MIMO wireless communication system. Described herein are systems, methods, and apparatus for measuring and reporting CSI for multiple sets of antenna ports. The measurement and reporting of CSI may be based on a single CSI report configuration (e.g., a single CSI-reportConfig) or multiple CSI report configurations (e.g., multiple CSI-reportConfigs).

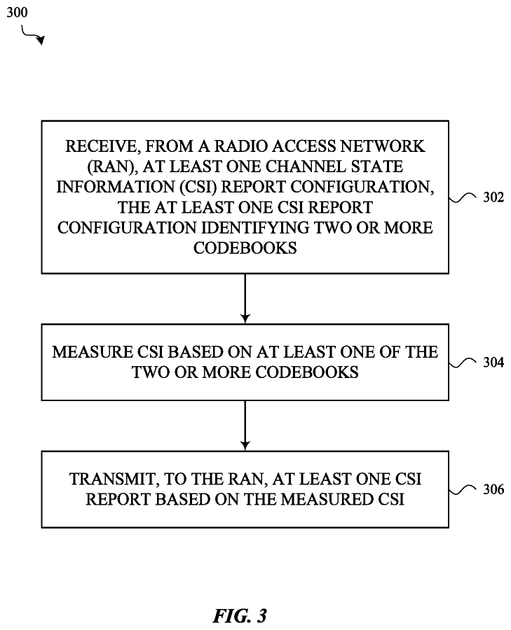

FIG. 3 shows an example method 300 of wireless communication by a UE, which method 300 may be used to configure measurement and reporting of CSI for multiple sets of antenna ports. The method 300 may be performed by a processor of the UE, and transmissions and receptions initiated by the processor may be made using a transceiver of the UE.

At 302, the method 300 may include receiving, from a RAN, at least one CSI report configuration (e.g., at least one CSI-reportConfig). The CSI report configuration(s) may identify two or more (N) codebooks. Each codebook of the N codebooks may be based on a respective set of antenna ports of two or more sets of antenna ports (i.e., two or more sets of antenna ports). The two or more sets of antenna ports may include a first set of antenna ports and one or more additional sets of antenna ports. The first set of antenna ports may have a largest number of antenna ports. Each of the one or more additional sets of antenna ports may include a respective set of antenna ports and, in some cases, each of the one or more additional sets of antenna ports may include a respective set of antenna ports selected from the first set of antenna ports (e.g., a subset of some or all of the antenna ports in the first set of antenna ports).

At 304, the method 300 may include measuring CSI based on at least one of the N codebooks.

At 306, the method 300 may include transmitting, to the RAN, at least one CSI report based on the measured CSI.

In some embodiments, the at least one CSI report configuration may be a single CSI report configuration, and the single CSI report configuration may include a codebook list (e.g., a list identifying (e.g., configuring) N codebooks based on N respective sets of antenna ports, with N≥2). In other embodiments, the at least one CSI report configuration may include multiple CSI report configurations, with each CSI report configuration identifying (e.g., configuring) a different codebook based on a different set of antenna ports. The RAN's use of a single CSI report configuration may reduce overhead, but the RAN's use of multiple CSI report configurations can in some cases provide more flexibility in CSI measurement and reporting (e.g., an ability for the RAN to trigger one or more subsets of CSI report configurations). In the case of multiple CSI report configurations, the multiple CSI report configurations may be linked. In these cases, the method 300 may include receiving, from the RAN, an indication of a linkage between the multiple linked CSI report configurations. In some cases, the indication may be received in higher layer signaling, such as radio resource control (RRC) signaling or a medium access control (MAC) control element (CE) (MAC CE).

Each codebook may be used to measure CSI and generate a CSI report (or part of a larger CSI report) based on a respective set of antenna ports. In some embodiments, the first set of antenna ports (i.e., the set of antenna ports having the largest number of antenna ports) may include all of the antenna ports from which the UE could possibly receive a downlink transmission from the RAN. In other embodiments, the first set of antenna ports may include only some of the antenna ports from which the UE could possibly receive a downlink transmission from the RAN. The first set of antenna ports may include one or more antenna ports (N1*N2 antenna ports) on each of one or more antenna panels (K antenna panels), which one or more antenna panels may be provided on one or more base stations (e.g., one or more gNBs) of the RAN.

Each of the one or more additional sets of antenna ports may include fewer antenna ports than are in the first set (or largest number) of antenna ports. The antenna ports of each additional set of antenna ports may be selected from the first set of antenna ports and may include antenna ports on fewer than K antenna panels (e.g., when K>1), or fewer antenna ports per antenna panel (e.g., when N1*N2>1), or fewer antenna ports on fewer antenna panels. When the antenna ports of a set are on fewer than K antenna panels, the antenna ports may be on the same or fewer number of base stations as the number of base stations that provide the first set of antenna ports.

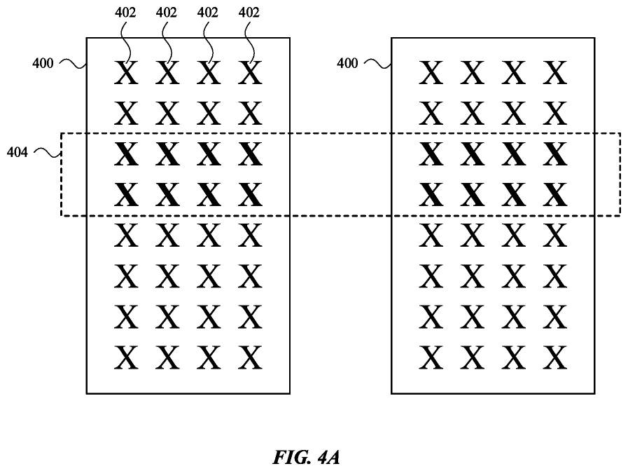

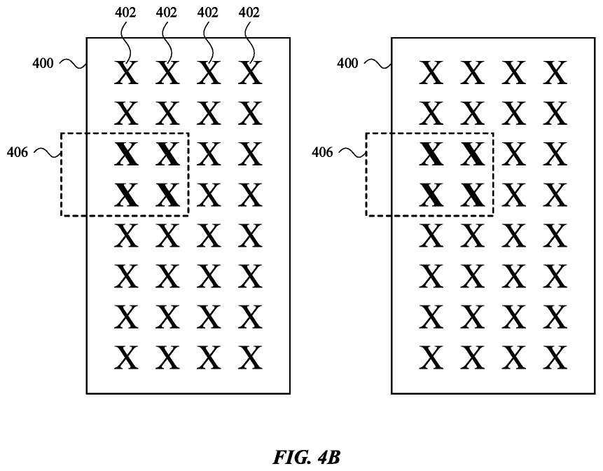

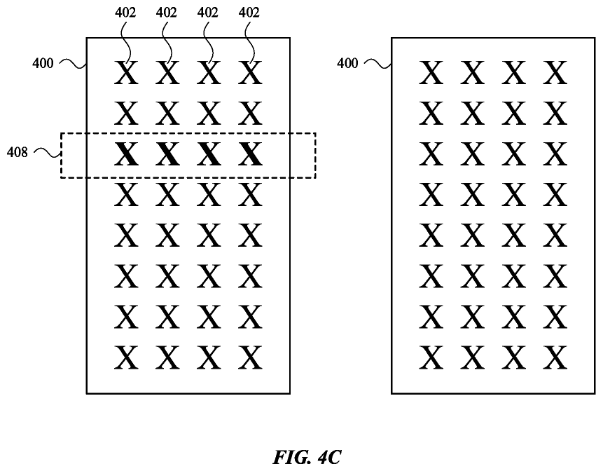

FIGS. 4A-4C show example sets of antenna ports on which the codebooks identified in one or more CSI report configurations may be based. By way of example, the sets of antenna ports are based on different numbers of antenna panels and antenna ports.

In each of FIGS. 4A-4C, an antenna panel 400 is indicated by a solid-line rectangle, and an antenna port 402 is indicated by an X. FIG. 4A shows two antenna panels 400, with each antenna panel 400 having a respective 32 antenna ports 402. A set of antenna ports 404 on which a first codebook is based is identified by a dashed-line rectangle. By way of example, the set of antenna ports 404 is shown to include (N1, N2)=(4, 2) antenna ports 402 on each antenna panel 400. The antenna panels 400 may be provided on the same base station or on different base stations. The antenna ports 402 included in the set of antenna ports 404 are indicated by darker Xs.

FIG. 4B shows a second set of antenna ports 406. The second set of antenna ports 406 may be associated with a second codebook and may be one of the additional sets of antenna ports described with reference to FIG. 3. By way of example, the second set of antenna ports 406 is shown to include (N1, N2)=(2, 2) antenna ports 402 on each antenna panel 400.

FIG. 4C shows a third set of antenna ports 408. The third set of antenna ports 408 may be associated with a third codebook and may be another one of the additional sets of antenna ports described with reference to FIG. 3. By way of example, the third set of antenna ports 408 is shown to include (N1, N2)=(4, 1) antenna ports 402 on only one antenna panel 400.

Returning to the method 300 of FIG. 3, and in some cases, the method 300 may include measuring, at 304, CSI based on each of the N codebooks identified in the at least one CSI report configuration, and including, in the at least one CSI report transmitted at 306, the measured CSI based on each of the N codebooks. The content of each CSI report may be indicated by reportQuantity.

Alternatively, the method 300 may include measuring, at 304, CSI based on a subset of X codebooks in the N codebooks identified in the at least one CSI report configuration. The subset of codebooks may include fewer than all of the codebooks in the N codebooks (i.e., X<N). The UE may then include, in the at least one CSI report transmitted at 306, the measured CSI based on each of the X codebooks. The value of X, or maximum value of X, may be configured by the RAN (e.g., by a base station of the RAN). In some embodiments, the X codebooks may be selected based on L1/L2 signaling (e.g., in a MAC CE or downlink control information (DCI)). In some embodiments, the X codebooks may be based on a report transmitted by the UE. For example, the UE may transmit indices of the X codebooks to the RAN, along with the at least one CSI report transmitted at 306. In some cases, the method 300 may include receiving, from the RAN (e.g., from a base station of the RAN) a target spectrum efficiency (SE). In these cases, the UE may use the target SE to determine what CSI should be reported. For example, the UE can determine to report CSI having an SE above the target SE and select (for reporting) the CSI based on the smallest number of antenna ports and/or smallest number of antenna panels. Alternatively (or additionally) to receiving a target SE from the RAN, the method 300 may include receiving, from the RAN, a target SE gap, with the target SE gap having the best SE from the largest codebook as a reference. For example, the UE can determine to report CSI having an SE above the threshold {best SE-SE gap} and select (for reporting) the CSI based on the smallest number of antenna ports and/or smallest number of panels.

In some embodiments, the method 300 may include receiving, from the RAN and in RRC signaling, an indication to measure CSI using a set of one or more codebooks (X codebooks, with X≤N) in the N codebooks identified in the at least one CSI report configuration. The UE may then measure CSI based on the set of one or more codebooks (X codebooks) and include, in the at least one CSI report transmitted at 306, the measured CSI based on the set of one or more codebooks. The value of X, or maximum value of X, may be configured by the RAN (e.g., by a base station of the RAN).

Various options are available for configuring a minimal Z value, a minimal Z′ value, and/or a CPU counting rule for the method 300 described with reference to FIG. 3. In a first option, the method 300 may include allocating, for measuring CSI in accordance with the at least one CSI report configuration, a CPU per codebook of the N codebooks. In other words, the N codebooks may occupy N CPUs. In these embodiments, the minimum Z and Z′ values defined by current 3GPP specifications may be used. The CPU occupancy rule defined by 3GPP specifications may also be used, and may be applied separately for each codebook (as a separate CPU occupancy rule per codebook), or as a common CPU occupancy rule applicable to all of the N codebooks.

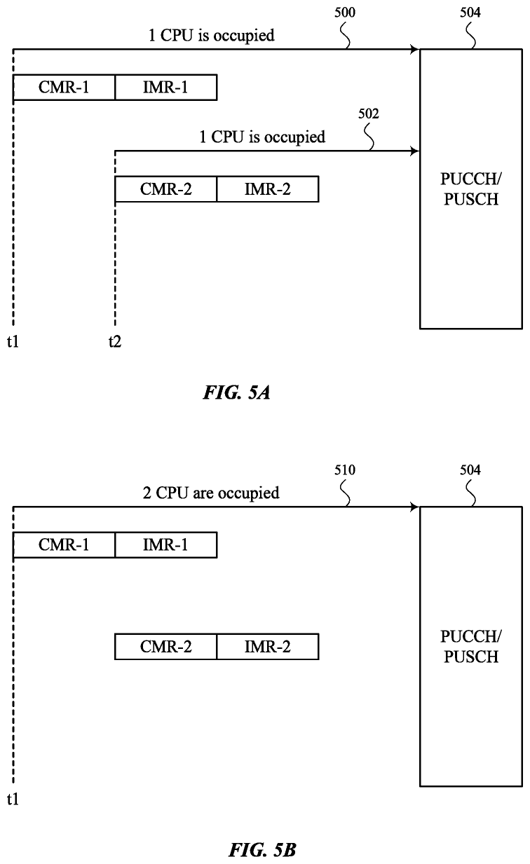

FIG. 5A shows application of separate CPU occupancy rules 500, 502 to different codebooks, with a first codebook being associated with measurement and reporting of CSI based on CMR-1/IMR-1, and a second codebook being associated with measurement and reporting of CSI based on CMR-2/IMR-2. In accord with the CPU occupancy rules 500, 502, a CPU is occupied for each codebook from a time t1 or t2 (beginning with a use of the respective codebook to measure CSI) to transmission of a CSI report in PUCCH/PUSCH 504.

FIG. 5B shows application of a common CPU occupancy rule 510 to multiple codebooks, with a first codebook being associated with measurement and reporting of CSI based on CMR-1/IMR-1, and a second codebook being associated with measurement and reporting of CSI based on CMR-2/IMR-2. In accord with the CPU occupancy rule 510, CPUs are occupied for both codebooks from a time t1 (beginning with a use of the first codebook to measure CSI) to transmission of a CSI report in PUCCH/PUSCH 504.

In a second option, the method 300 may include adjusting the minimum Z value and the minimum Z′ value based on the number of codebooks in the N codebooks. In these embodiments, the CPU occupancy rule defined by 3GPP specifications may be used, and may be applied separately for each codebook, or as a common CPU occupancy rule applicable to all of the N codebooks.

In a third option, the method 300 may include allocating, for measuring and reporting CSI in accordance with the at least one CSI report configuration, a number of CPUs that is based on a value of a constant (u) and a number of codebooks (N) in the N codebooks. For example, u*N CPUs may be allocated to measure and report CSI for the N codebooks, where 0<u<1. In these embodiments, the minimum Z and Z′ values may need to be adjusted. For example, the method 300 may include adjusting the minimum Z and Z′ values based on the value of the constant (u) and the number of codebooks (N) in the N codebooks. The value of the constant (u) may be reported to the network (e.g., to the RAN) in UE capability information or reported to the UE in RRC signaling.

In a fourth option (and/or in combination with some of the first through third options), the method 300 may include transmitting, to the RAN, a UE capability for at least one of a CPU configuration, a CPU occupancy rule, a minimum Z value, or a minimum Z′ value, and/or receiving in RRC signaling, from the RAN, at least one of the CPU configuration, the CPU occupancy rule, the minimum Z value, or the minimum Z′ value.

In embodiments in which a single CSI report configuration is received by the UE, the method 300 may be further adapted as described below.

For CMR/IMR configuration, the CSI report configuration received at 302 may in some cases identify a CMR or CMR set per codebook (e.g., N CMRs or CMR sets for N codebooks). In the case of N CMRs, all of the codebooks may share the same CSI-IM resource and/or NZP-IMR. Alternatively, different CSI-IM resources and/or NZP-IMRs can be configured for different codebooks. The CSI-RS resources in the CMR/IMR sets may be from the sets of antenna ports selected from the first set (or largest number) of antenna ports. In the case of N CMR sets, all of the codebooks may share the same CSI-IM resource sets and/or NZP-IMR sets. Alternatively, different CSI-IM resource sets and/or NZP-IMR sets can be configured for different codebooks. The CSI-RSs with the same index, within the N−1 CMR/IMR sets for the N−1 codebook(s) that are based on respective sets of antenna ports selected from the first set (or largest number) of antenna ports, may be received from a same set of antenna ports (i.e., from one of the one or more additional sets of antenna ports for which CSI is measured and reported).

Alternatively, the CSI report configuration received by the UE may identify a list of CMRs/IMRs for the first set (or largest number) of antenna ports. When deriving CSI based on codebooks other than the codebook that is based on the first set of antenna ports, the method 300 may include identifying, for a codebook based on a set of antenna ports of the one more additional sets of antenna ports, a set of CMRs/IMRs (i.e., a subset of CMRs/IMRs) in the list of CMRs/IMRs for the first set of antenna ports.

In embodiments in which multiple CSI report configurations (and in some cases multiple linked CSI report configurations) are received by the UE, the method 300 may be further adapted as described below.

In some embodiments, the multiple CSI report configurations may have a same configuration for at least one of the following parameters: a report configuration type (reportConfigType); a report quantity (reportQuantity); a report frequency configuration (reportFreqConfiguration); a first time restriction for channel measurements (timeRestrictionFor ChannelMeasurements); a second time restriction for frequency measurements (timeRestrictionForInterference Measurements); a channel quality indicator (CQI) table (cqi-Table); or a subband size (subbandSize).

For CMR/IMR configurations, the method 300 may include receiving CMRs/IMRs for different sets of the two or more sets of antenna ports. The CSI-RSs with the same index, within the CMR/IMR sets for the N−1 codebook(s) that are based on respective sets of antenna ports selected from the first set (or largest number) of antenna ports, may be received from a same set of antenna ports (i.e., from one of the one or more additional sets of antenna ports for which CSI is measured and reported). Alternatively, the method 300 may include receiving CMRs for the first set of antenna ports, and identifying, for a codebook based on a set of antenna ports of the one or more additional sets of antenna ports, a set of CMRs in the received CMRs.

When multiple CSI report configurations are linked, the method 300 may include identifying a trigger to measure and report CSI for at least one of the codebooks identified by the multiple linked CSI report configurations and, in response to the trigger, measuring and reporting CSI for all of the codebooks identified by the multiple linked CSI report configurations. In other words, the triggering of CSI measurement and reporting for any one codebook triggers CSI measurement and reporting for all codebooks. Alternatively, the method 300 may include receiving, from the RAN, a set of one or more triggers to measure and report CSI, and each trigger in the set of one or more triggers may trigger the UE's measurement and reporting of CSI for a respective codebook identified by the multiple linked CSI report configurations. In other words, the measurement and reporting of CSI based on a particular codebook may be triggered for each codebook individually. In the case of individually-triggered codebooks, a minimum Z value, minimum Z′ value, and CPU occupancy rule should be determined per triggered codebook or per the set of triggered codebooks.

For dynamic point(s) selection, one CSI-RS configured as a CMR and/or IMR may be transmitted from one or more than one TRP. When a CSI-RS is transmitted from multiple TRPs, the number of antenna panels in a codebook that relies on the CMR/IMR should be greater than one. In some cases, the RAN may configure different transmission powers or different transmission power offsets and associated SSB transmission powers for different antenna panels.

For network power saving, one CSI-RS may be associated with different transmission powers or transmission power offsets and associated SSB transmission powers. Different CSI-RS may be associated with different transmission powers. Alternatively, a base station may configure a list of power offsets for a UE to report CSI measured for one CSI-RS. In some cases, a UE may report the preferred power offset(s) or CSI-RS resource indicator(s) (CRI(s)) as well as their corresponding CSI. In some cases, the preferred power offset(s) or CRI(s) may be based on a configured target SE or target SE gap, with the CSI-RS with the largest transmission power as a reference. Alternatively, the UE can report N CSIs for N configured power offsets. As an extension, and to reduce the overhead for a CSI report, one or more common fields may be reported for the N CSIs. For example, a common rank indicator (RI), precoding matrix indicator (PMI), or layer indicator (LI) may be reported. After receiving the CSI report, the network can transmit a downlink signal using an appropriate power.

For N codebooks that are defined in a scalable way, a UE may report one PMI based on the codebook that is, in turn, based on the largest number of antenna ports. The UE may report N CQIs for the N codebooks, and 1 or N RIs for the N codebooks. If 1 RI is reported, 1 LI can be reported. If N RIs are reported, N LIs can be reported. After receiving the PMI, a RAN can calculate the best transmission direction for each set of antenna ports.

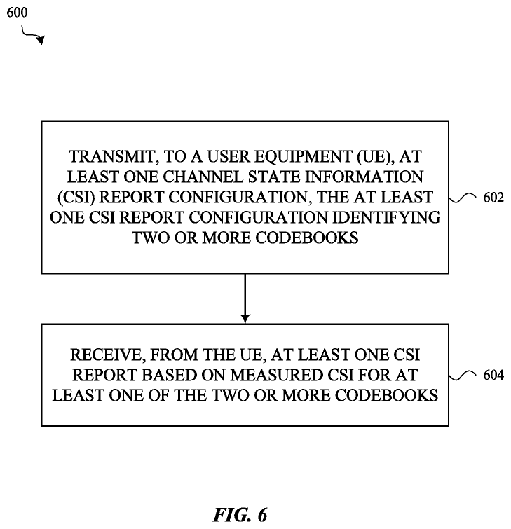

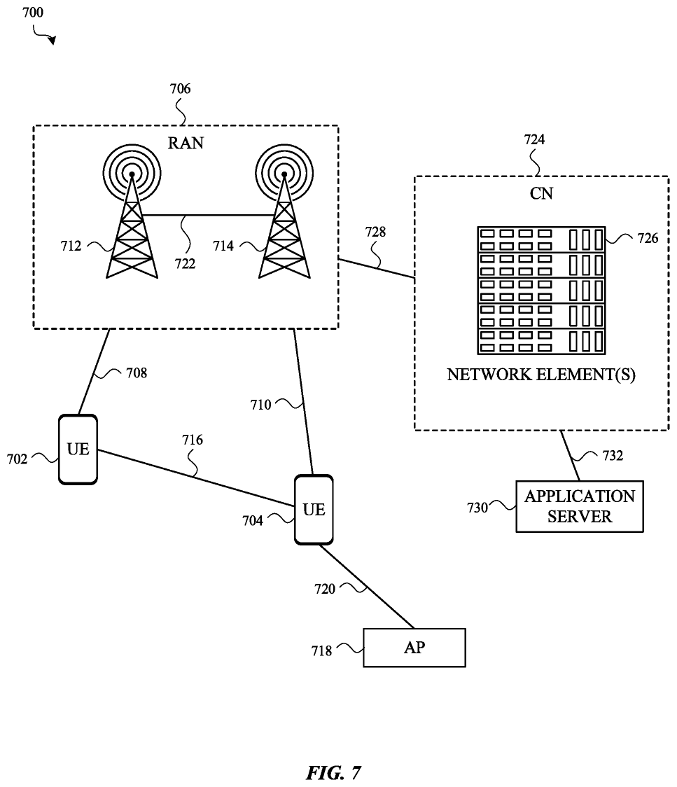

FIG. 6 shows an example method 600 of wireless communication by a base station, which method 600 may be used to configure measurement and reporting of CSI for multiple sets of antenna ports. The method 600 may be performed by a processor of the base station, and transmissions and receptions initiated by the processor may be made using a transceiver of the base station.

At 602, the method 600 may include transmitting, to a UE, at least one CSI report configuration (e.g., at least one CSI-reportConfig). The CSI report configuration(s) may identify two or more (N) codebooks. Each codebook of the N codebooks may be based on a respective set of antenna ports of two or more sets of antenna ports (i.e., two or more sets of antenna ports). The two or more sets of antenna ports may include a first set of antenna ports having a largest number of antenna ports, and one or more additional sets of antenna ports. Each of the one or more additional sets of antenna ports may include a respective set of antenna ports and, in some cases, each of the one or more additional sets of antenna ports may include a respective set of antenna ports selected from the first set of antenna ports (e.g., a subset of some or all of the antenna ports in the first set of antenna ports).

At 604, the method 600 may include receiving, from the UE, at least one CSI report based on the measured CSI.

Embodiments contemplated herein include an apparatus having means to perform one or more elements of the method 300 or 600. In the context of method 300, the apparatus may be, for example, an apparatus of a UE (such as a wireless device 802 that is a UE, as described herein). In the context of method 600, the apparatus may be, for example, an apparatus of a base station (such as a network device 820 that is a base station, as described herein).

Embodiments contemplated herein include one or more non-transitory computer-readable media storing instructions to cause an electronic device, upon execution of the instructions by one or more processors of the electronic device, to perform one or more elements of the method 300 or 600. In the context of method 300, the non-transitory computer-readable media may be, for example, a memory of a UE (such as a memory 806 of a wireless device 802 that is a UE, as described herein). In the context of method 600, the non-transitory computer-readable media may be, for example, a memory of a base station (such as a memory 824 of a network device 820 that is a base station, as described herein).

Embodiments contemplated herein include an apparatus having logic, modules, or circuitry to perform one or more elements of the method 300 or 600. In the context of method 300, the apparatus may be, for example, an apparatus of a UE (such as a wireless device 802 that is a UE, as described herein). In the context of method 600, the apparatus may be, for example, an apparatus of a base station (such as a network device 820 that is a base station, as described herein).

Embodiments contemplated herein include an apparatus having one or more processors and one or more computer-readable media, using or storing instructions that, when executed by the one or more processors, cause the one or more processors to perform one or more elements of the method 300 or 600. In the context of method 300, the apparatus may be, for example, an apparatus of a UE (such as a wireless device 802 that is a UE, as described herein). In the context of the method 600, the apparatus may be, for example, an apparatus of a base station (such as a network device 820 that is a base station, as described herein).

Embodiments contemplated herein include a signal as described in or related to one or more elements of the method 300 or 600.

Embodiments contemplated herein include a computer program or computer program product having instructions, wherein execution of the program by a processor causes the processor to carry out one or more elements of the method 300 or 600. In the context of method 300, the processor may be a processor of a UE (such as a processor(s) 804 of a wireless device 802 that is a UE, as described herein), and the instructions may be, for example, located in the processor and/or on a memory of the UE (such as a memory 806 of a wireless device 802 that is a UE, as described herein). In the context of method 600, the processor may be a processor of a base station (such as a processor(s) 822 of a network device 820 that is a base station, as described herein), and the instructions may be, for example, located in the processor and/or on a memory of the base station (such as a memory 824 of a network device 820 that is a base station, as described herein).

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

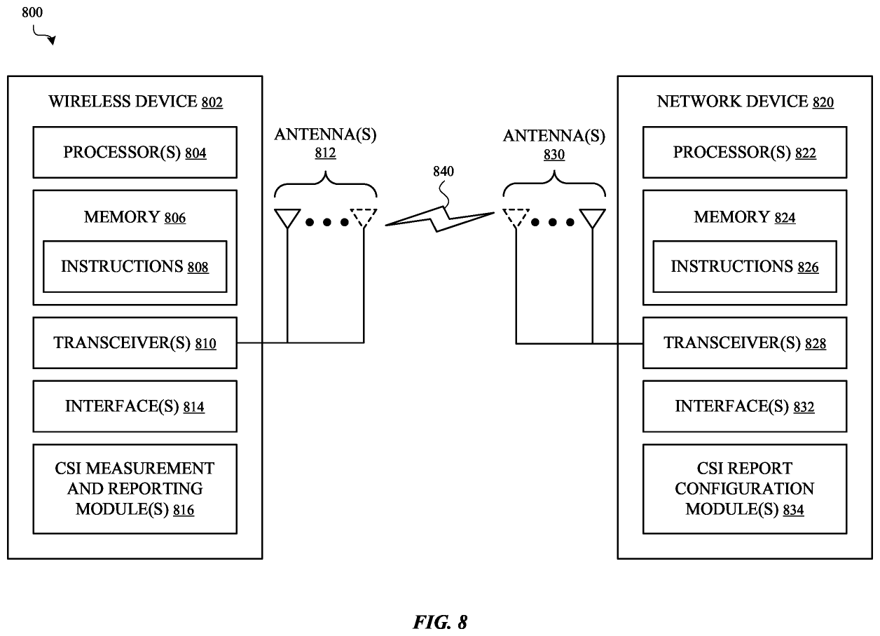

FIG. 8 illustrates a system 800 for performing signaling 840 between a wireless device 802 and a network device 820, according to embodiments disclosed herein. The system 800 may be a portion of a wireless communication system as herein described. The wireless device 802 may be, for example, a UE of a wireless communication system. The network device 820 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 840) to and/or from the wireless device 802 with other devices (e.g., the network device 820) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include one or more CSI measurement and reporting module(s) 816. The CSI measurement and reporting module(s) 816 may be implemented via hardware, software, or combinations thereof. For example, the CSI measurement and reporting module(s) 816 may be implemented as a processor, circuit, and/or instructions 808 stored in the memory 806 and executed by the processor(s) 804. In some examples, the CSI measurement and reporting module(s) 816 may be integrated within the processor(s) 804 and/or the transceiver(s) 810. For example, the CSI measurement and reporting module(s) 816 may be implemented by a combination of software components (e.g., executed by a DSP or a general processor) and hardware components (e.g., logic gates and circuitry) within the processor(s) 804 or the transceiver(s) 810.

The CSI measurement and reporting module(s) 816 may be used for various aspects of the present disclosure, for example, aspects of FIGS. 1-6. The CSI measurement and reporting module(s) 816 may be configured to, for example, configure CSI measurement and reporting and transmit one or more CSI reports to another device (e.g., to the network device 820).

The network device 820 may include one or more processor(s) 822. The processor(s) 822 may execute instructions such that various operations of the network device 820 are performed, as described herein. The processor(s) 804 may include one or more baseband processors implemented using, for example, a CPU, a DSP, an ASIC, a controller, an FPGA device, another hardware device, a firmware device, or any combination thereof configured to perform the operations described herein.

The network device 820 may include a memory 824. The memory 824 may be a non-transitory computer-readable storage medium that stores instructions 826 (which may include, for example, the instructions being executed by the processor(s) 822). The instructions 826 may also be referred to as program code or a computer program. The memory 824 may also store data used by, and results computed by, the processor(s) 822.

The network device 820 may include one or more transceiver(s) 828 that may include RF transmitter and/or receiver circuitry that use the antenna(s) 830 of the network device 820 to facilitate signaling (e.g., the signaling 840) to and/or from the network device 820 with other devices (e.g., the wireless device 802) according to corresponding RATs.

The network device 820 may include one or more antenna(s) 830 (e.g., one, two, four, or more). In embodiments having multiple antenna(s) 830, the network device 820 may perform MIMO, digital beamforming, analog beamforming, beam steering, etc., as has been described.

The network device 820 may include one or more interface(s) 832. The interface(s) 832 may be used to provide input to or output from the network device 820. For example, a network device 820 that is a base station may include interface(s) 832 made up of transmitters, receivers, and other circuitry (e.g., other than the transceiver(s) 828/antenna(s) 830 already described) that enables the base station to communicate with other equipment in a core network, and/or that enables the base station to communicate with external networks, computers, databases, and the like for purposes of operations, administration, and maintenance of the base station or other equipment operably connected thereto.

The network device 820 may include one or more CSI report configuration module(s) 834. The CSI report configuration module(s) 834 may be implemented via hardware, software, or combinations thereof. For example, the CSI report configuration module(s) 834 may be implemented as a processor, circuit, and/or instructions 826 stored in the memory 824 and executed by the processor(s) 822. In some examples, the CSI report configuration module(s) 834 may be integrated within the processor(s) 822 and/or the transceiver(s) 828. For example, the CSI report configuration module(s) 834 may be implemented by a combination of software components (e.g., executed by a DSP or a general processor) and hardware components (e.g., logic gates and circuitry) within the processor(s) 822 or the transceiver(s) 828.

The CSI report configuration module(s) 834 may be used for various aspects of the present disclosure, for example, aspects of FIGS. 1-6. The CSI report configuration module(s) 834 may configure CSI reports that are to be transmitted by another device (e.g., the wireless device 802).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to,
receive, from a radio access network (RAN) and via the transceiver, at least one channel state information (CSI) report configuration, the at least one CSI report configuration identifying two or more codebooks, each codebook of the two or more codebooks based on a respective set of antenna ports of two or more sets of antenna ports, the two or more sets of antenna ports including,
a first set of antenna ports; and
one or more additional sets of antenna ports, each of the one or more additional sets of antenna ports including a respective set of antenna ports selected from the first set of antenna ports;
measure CSI based on at least one of the two or more codebooks; and
transmit, to the RAN and via the transceiver, at least one CSI report based on the measured CSI.

2. The UE of claim 1, wherein:
the first set of antenna ports comprises antenna ports on K antenna panels, with N1*N2 antenna ports per antenna panel; and
at least one of the one or more additional sets of antenna ports includes,
antenna ports on fewer than K antenna panels;
fewer antenna ports per antenna panel; or
fewer antenna ports on fewer antenna panels.

3. The UE of claim 1, wherein:
the processor is configured to,
measure CSI based on each of the two or more codebooks; and
include, in the at least one CSI report, the measured CSI based on each of the two or more codebooks.

4. The UE of claim 1, wherein:
the processor is configured to,
measure CSI based on a subset of codebooks in the two or more codebooks, the subset of codebooks including fewer than all of the codebooks in the two or more codebooks; and
include, in the at least one CSI report, the measured CSI based on the subset of codebooks.

5. The UE of claim 1, wherein:
the processor is configured to,
receive, from the RAN and via the transceiver, in radio resource control (RRC) signaling, an indication to measure CSI using a set of one or more codebooks in the two or more codebooks identified in the at least one CSI report configuration;
measure CSI based on the set of one or more codebooks; and
include, in the at least one CSI report, the measured CSI based on the set of one or more codebooks.

6. The UE of claim 1, wherein the processor is configured to allocate, for measuring and reporting CSI in accordance with the at least one CSI report configuration, a CSI processing unit (CPU) per codebook of the two or more codebooks.

7. The UE of claim 1, wherein:
the processor is configured to adjust a minimum Z value and a minimum Z′ value based on a number of codebooks in the two or more codebooks;
the minimum Z value is an offset between a last symbol of a physical downlink control channel (PDCCH) and a first symbol of a CSI report including an optional timing adjustment (TA); and
the minimum Z′ value is an offset between a last symbol of a channel measurement resource (CMR) or an interference measurement resource (IMR) and the first symbol of the CSI report including the optional TA.

8. The UE of claim 1, wherein:
the processor is configured to,
allocate, for measuring and reporting CSI in accordance with the at least one CSI report configuration, a number of CSI processing units (CPUs) based on a value of a constant and a number of codebooks in the two or more codebooks; and
adjust a minimum Z value and a minimum Z′ value based on the value of the constant and the number of codebooks in the two or more codebooks;
the minimum Z value is an offset between a last symbol of a physical downlink control channel (PDCCH) and a first symbol of a CSI report including an optional timing adjustment (TA); and
the minimum Z′ value is an offset between a last symbol of a channel measurement resource (CMR) or an interference measurement resource (IMR) and the first symbol of the CSI report including the optional TA.

9. The UE of claim 1, wherein:
the processor is configured to,
transmit, to the RAN and via the transceiver, a UE capability for at least one of a CSI processing unit (CPU) configuration, a CPU occupancy rule, a minimum Z value, or a minimum Z′ value; or
receive in radio resource control (RRC) signaling, from the RAN and via the transceiver, at least one of the CPU configuration, the CPU occupancy rule, the minimum Z value, or the minimum Z′ value;
the minimum Z value is an offset between a last symbol of a physical downlink control channel (PDCCH) and a first symbol of a CSI report including an optional timing adjustment (TA); and
the minimum Z′ value is an offset between a last symbol of a channel measurement resource (CMR) or an interference measurement resource (IMR) and the first symbol of the CSI report including the optional TA.

10. The UE of claim 1, wherein the at least one CSI report configuration is a single CSI report configuration.

11. The UE of claim 10, wherein the single CSI report configuration identifies a channel measurement resource (CMR) or CMR set per codebook of the two or more codebooks.

12. The UE of claim 10, wherein:
the single CSI report configuration identifies a list of CMRs for the first set of antenna ports; and
the processor is configured to identify, for a codebook based on a set of antenna ports of the one or more additional sets of antenna ports, a set of CMRs in the list of CMRs.

13. The UE of claim 1, wherein:
the at least one CSI report configuration comprises multiple linked CSI report configurations; and
the processor is configured to receive, from the RAN and via the transceiver, an indication of a linkage between the multiple linked CSI report configurations.

14. The UE of claim 13, wherein the multiple linked CSI report configurations have a same configuration for at least one of:
a report configuration type;
a report quantity;
a report frequency configuration;
a first time restriction for channel measurements;
a second time restriction for frequency measurements;
a channel quality indicator (CQI) table; or
a subband size.

15. The UE of claim 13, wherein the processor is configured to receive CMRs for different sets of the two or more sets of antenna ports.

16. The UE of claim 13, wherein:
the processor is configured to,
receive CMRs for the first set of antenna ports; and
identify, for a codebook based on a set of antenna ports of the one or more additional sets of antenna ports, a set of CMRs in the received CMRs.

17. The UE of claim 13, wherein:
the processor is configured to,
identify a trigger to measure and report CSI for at least one codebook identified by the multiple linked CSI report configurations; and
in response to the trigger, measure and report CSI for all of the codebooks identified by the multiple linked CSI report configurations.

18. The UE of claim 13, wherein:
the processor is configured to,
receive, from the RAN and via the transceiver, a set of one or more triggers to measure and report CSI, each trigger in the set of one or more triggers triggering a measurement and reporting of CSI for a respective codebook identified by the multiple linked CSI report configurations.

19. A method of a user equipment (UE), comprising:
receiving, from a radio access network (RAN), at least one channel state information (CSI) report configuration, the at least one CSI report configuration identifying two or more codebooks, each codebook of the two or more codebooks based on a respective set of antenna ports of two or more sets of antenna ports, the two or more sets of antenna ports including,
a first set of antenna ports; and
one or more additional sets of antenna ports, each of the one or more additional sets of antenna ports including a respective set of antenna ports selected from the first set of antenna ports;
measuring CSI based on at least one of the two or more codebooks; and
transmitting, to the RAN, at least one CSI report based on the measured CSI.

20. A base station, comprising:
a transceiver; and
a processor configured to,
transmit, to a user equipment (UE) and via the transceiver, at least one channel state information (CSI) report configuration, the at least one CSI report configuration identifying two or more codebooks, each codebook of the two or more codebooks based on a respective set of antenna ports of two or more sets of antenna ports, the two or more sets of antenna ports including,
a first set of antenna ports; and
one or more additional sets of antenna ports, each of the one or more additional sets of antenna ports including a respective set of antenna ports selected from the first set of antenna ports; and
receive, from the UE and via the transceiver, at least one CSI report based on measured CSI for at least one of the two or more codebooks.
